(19) United States
(12) Patent Application Publication
(10) Pub. No.: US 2015/0100509 A1
(43) Pub. Date: Apr. 9, 2015

(54) SYSTEMS AND METHODS FOR ENHANCING USER ENGAGEMENT

(71) Applicant: salesforce.com, inc., San Francisco, CA (US)

(72) Inventors: Jonathan Pappas, San Francisco, CA (US); Scott Douglas White, Seattle, CA (US); Marcus Ericsson, San Francisco, CA (US); Joel Palmert, Stockholm (SE); Xiao Meng, San Francisco, CA (US)

(21) Appl. No.: 14/511,061

(22) Filed: Oct. 9, 2014

Related U.S. Application Data
(60) Provisional application No. 61/888,756, filed on Oct. 9, 2013.
(60) Provisional application No. 61/888,765, filed on Oct. 9, 2013.
(60) Provisional application No. 61/888,770, filed on Oct. 9, 2013.
(60) Provisional application No. 61/888,779, filed on Oct. 9, 2013.
(60) Provisional application No. 61/888,785, filed on Oct. 9, 2013.

(51) Int. Cl. G06Q 50/00; G06Q 30/02; G06F 17/30

(52) U.S. Cl. CPC G06Q 50/01; G06F 17/3053; G06Q 30/02
USPC 705/319; 707/723

(57) ABSTRACT

Methods and systems are provided for enhancing user engagement in a social network computing environment by using affinity indices to track the interaction among posts, topics, users, groups, and experts, and populating displays on user, group, and topic pages using the affinity indices.

### CROSS-REFERENCE TO RELATED APPLICATIONS

This application claims the benefit of the following U.S. provisional patent applications: i) Ser. No. 61/888,756 filed Oct. 9, 2013; ii) Ser. No. 61/888,765 filed Oct. 9, 2013; iii) Ser. No. 61/888,770 filed Oct. 9, 2013; iv) Ser. No. 61/888,779 filed Oct. 9, 2013; and v) Ser. No. 61/888,785 filed Oct. 9, 2013. The entire contents of all of the foregoing applications are incorporated herein by this reference.

### TECHNICAL FIELD

Embodiments of the subject matter described herein relate generally to computer systems and applications for enhancing user engagement with social networks, and more particularly to techniques for enriching the interaction among posts, topics, users, and experts.

### BACKGROUND

The unprecedented growth of social technologies has redefined the way people connect and communicate. On-line social networking sites and tools such as Facebook™, Pinterest™, Tumblr™, Google+™, Hootsuite™, and Twitter™ have forever changed the way people share information and otherwise communicate with each other. In business environments, collaborative sites have changed the way groups of related users (e.g., “Deal Teams”) share information about sales opportunities or other issues surrounding products or services pursued or offered by the team. Presently known enterprise social network platforms such as Chatter™, released in June 2010 by Salesforce™ and available at www.salesforce.com, provide users with a feed-based stream of posts for tracked objects. Chatter™ users track projects and sales opportunities, solicit input from knowledgeable colleagues, and otherwise enrich the social networking experience through updates about coworkers, customers, topics of interest, and business objects, sometimes referred to as “feed tracked changes”, or FTCs. Users can also form groups and post messages on each other's profiles to facilitate collaboration and seek help from the community.

At the same time, software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation within tenant organizations without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

Presently known feed-based sites involve processing, storing, and displaying massive amounts of user data. Nonetheless, smart systems and methods are needed which more effectively exploit the inter-relationships among users, posts, topics, and experts.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures.

FIG. 1 is a schematic block diagram of a multi-tenant computing environment in accordance with an embodiment;

FIG. 2 is an exemplary layout of a feed-based user interface within a browser window in accordance with an embodiment;

FIG. 3 is a screen shot of an exemplary group or user page in accordance with an embodiment;

FIG. 4 is an affinity table which maps topics to users, groups, business objects, and other locations in accordance with an embodiment;

FIG. 5 is an affinity index illustrating the affinity of an exemplary topic to users, groups, business objects, and locations in accordance with an embodiment;

FIGS. 6-15 are screen shots of user, group, and topic pages in accordance with various embodiments;

FIG. 16 is an expertise table which maps points to users for various topics in accordance with an embodiment; and

FIG. 17 is a screen shot of a user page showing a drop down menu of experts displayed in response to the user invoking the expert notification protocols in accordance with an embodiment.

### DETAILED DESCRIPTION

Embodiments of the subject matter described herein generally relate to systems and methods for applying intelligence to the manner in which data pertaining to users, posts, topics, and experts are processed, stored and displayed.

Many social networking platforms such as SALESFORCE.COM™, Twitter™, and Facebook™, include user, group, and topic pages employing content feeds to present information in the form of a stream of posts. For example, the Chatter™ collaboration cloud is a web based enterprise file sharing solution that allows users to share, collaborate on, and manage files and other data objects with any number of authorized users or groups within their company or organization using a feed based paradigm. Using CHATTER™, users follow other users and topics such that changes or interactions may be viewed in a feed by users through mobile devices, desktop computers, tablet computers, and so forth.

While collaborative tools such as CHATTER enable users to share and consume information in a social manner, existing systems do not adequately address the integration of posts, users, topics, and experts. As a result, users may not be directed to the most relevant content or the most knowledgeable person through existing feed paradigms.

As explained in greater detail below, the present disclosure algorithmically tracks affinities among posts, users, topics, and experts and uses various widgets to present the resulting information on user pages, group pages, and topic pages. As used herein, the term widget refers to a computing application or module including code for performing specific background processes, such as transient and auxiliary applications that don't require user involvement.

In one embodiment, a recently talked about (RTA) widget highlights items on user and group detail pages that have recently been discussed by the user and/or group. The RTA widget gives readers a snapshot into what's important right now in the context of a particular group or user. The RTA algorithm may be configured to analyze the frequency and recency of relevant posts and comments. The recency component may employ a configurable time-decay feature (e.g., two months) for assigning greater weight to more recent posts, and correspondingly less weight to older posts. Other signals such as “likes” and re-shares can also be used in the RTA scoring analysis and weighted accordingly.

In another embodiment, a widget for suggesting post topics maintains an affinity table which maps the affinity of various topics to groups, users, and business objects (collectively referred to as locations) and recommends topics for users to tag to posts based on previous behavior. In this way, relevant viewership is increased by targeting posts to users and groups having a high affinity for the subject matter of the post. Over time, the affinity table can fine tune and thereby filter what might otherwise result in a fire hose of suggested topics.

In a further embodiment, the platform identifies and confirms experts based on the frequency with which a knowledgeable person's (also referred to as a candidate influencer) posts are recognized or ratified by other users. Various metrics may be used to score a candidate influencer's level of expertise, such as the number of times a person's posts are “liked”, @mentioned, or re-shared by others. In addition to the foregoing algorithmic component, a second “human” component may be used to enhance the reliability of an expert designation, namely, a deliberate endorsement from another user.

In another embodiment, topical experts are identified within a Q&A community based on answers to questions posed by members of the community. Points are awarded and tracked on a leaderboard based on correct and incorrect answers, with weights assigned to positive and negative points.

In a further embodiment, the system seamlessly connects users who have questions with experts who have answers by identifying and suggesting experts for users to consider engaging for a particular question. Upon selecting one or more of the suggested experts, the system automatically notifies the selected experts by displaying the question in the expert's feed.

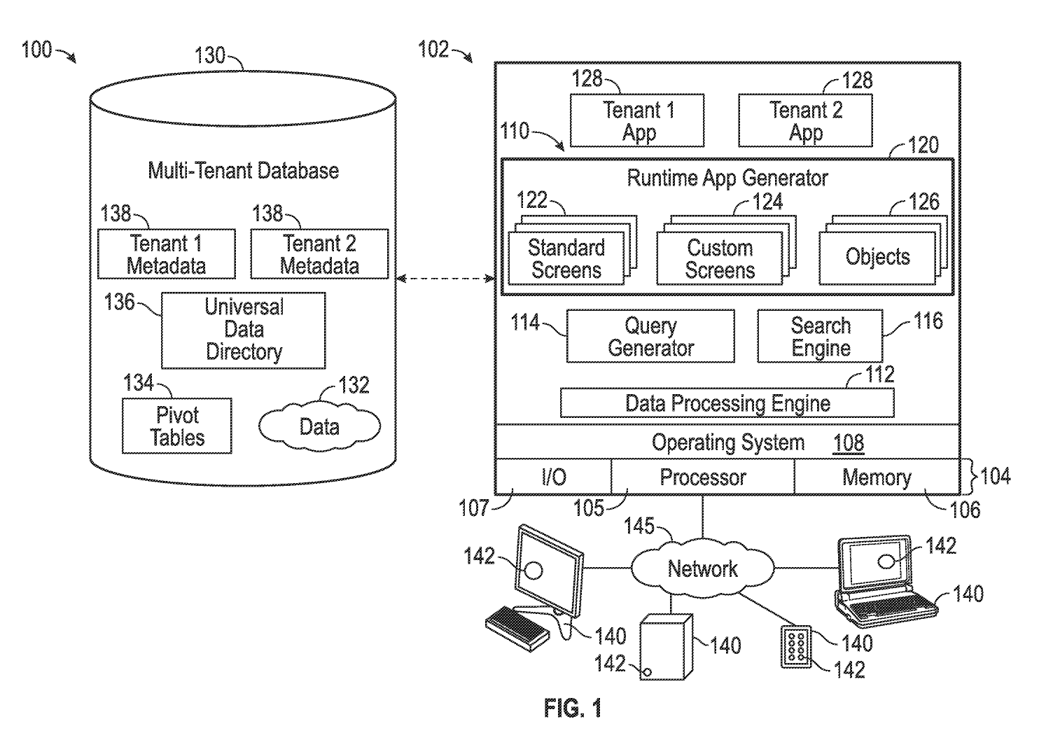

Turning now to FIG. 1, an exemplary cloud based solution may be implemented in the context of a multi-tenant system 100 including a server 102 that supports applications 128 based upon data 132 from a database 130 that may be shared between multiple tenants, organizations, or enterprises, referred to herein as a multi-tenant database. Data and services generated by the various applications 128 are provided via a network 145 to any number of client devices 140, such as desk tops, laptops, tablets, smartphones, Google Glass™, and any other computing device implemented in an automobile, aircraft, television, or other business or consumer electronic device or system, including web clients.

Each application 128 is suitably generated at run-time (or on-demand) using a common application platform 110 that securely provides access to the data 132 in the database 130 for each of the various tenant organizations subscribing to the service cloud 100. In accordance with one non-limiting example, the service cloud 100 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128. In various embodiments, application 128 embodies the functionality of a collaboration solution such as the Chatter system, described below.

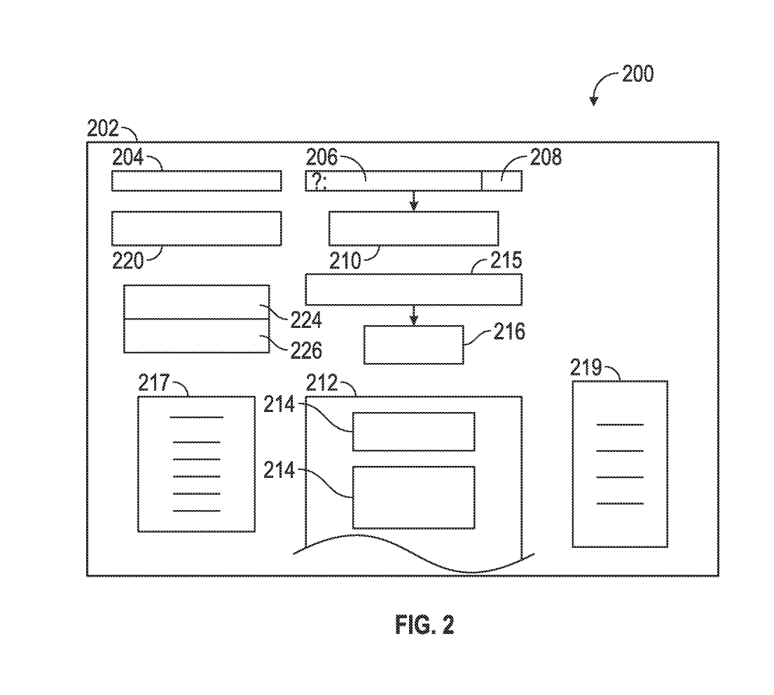

Referring now to FIG. 2, an exemplary layout 200 for a feed-based user interface includes a screen 202 within a browser window. The screen 202 may include one or more branding indicia 204 such as the company or organization name, logo, and the like, a login field 220. A search field 206, a “Go” (or “Search”) virtual button 208, and an optional deflection field 210 allow the user to enter search terms (e.g., in the form of keywords or questions) into the system. Group, user, topic, or community indicia 224 and user indicia 226 (which may include a user photo or avatar) may also be provided. For example, in the context of a group or collective page, indicia 224 may indicate one of several groups or communities associated with an organization or social network. Alternatively, in the context of an individual user's page, indicia 224 may set forth the user's profile. In yet a further alternative, in the context of a topic page, indicia 224 may define the topic or subject matter to which the page is dedicated.

Layout 200 further includes a feed 212 configured to sequentially display posts 214 such as questions, comments, business objects, and the like, a publisher 215 for composing posts, and a drop down suggestion box 216. Layout 200 may also include one or more display panels 217, 219 for presenting widget results. In particular, in the context of a topic, group, or community page, the display panel 217 may comprise a list of people knowledgeable in the subject matter of the topic or community, and the display panel 219 may comprise a list of groups currently discussing the same subject matter. Alternatively, in the context of a user, group, or community page the display panel may comprise a list of recently talked about (RTA) topics. It should be appreciated that layout 200 is merely exemplary, and that user interface pages may include any combination or sub-combination of the foregoing and any number of additional components, display panels, and the like.

As explained in greater detail below, various algorithms, widgets affinity tables, and other relational database structures may be employed to track, calculate, score, and otherwise process information and data relating to users, groups, experts, communities, topics, business objects, posts, comments, questions, answers, likes, @mentions, re-shares, and other metrics. The results of these processes may be used to populate the displays 217, 219, as also described in greater detail below.

To facilitate the ensuing discussion, the present disclosure is conceptually divided into the following five inter-related sections: i) ranking and displaying recently talked about (RTA) topics; ii) suggesting topics to tag posts with based on affinity indices; iii) two stage protocol for qualifying experts including an algorithmic component and a manual endorsement component; iv) identifying topical experts within a Q&A community based on correct and incorrect answers to questions; and v) connecting users with candidate experts and displaying questions in the feeds of those experts selected by users. These five categories will now be discussed in seriatim.

### Recently Talked about Topics

With the boom in social networking applications, organizations seek features that generate user interest and engagement, such as user personalization which allows users to determine some of the content they see. For example, user personalization allows users to categorize posts in their feeds (e.g., by using hash tags). Current categorization techniques are limited in that they require the user to select from a predefined group of topics that are universal to the system. This comprises the flexibility and precision users desire in tagging their posts with customizable topics.

In an embodiment, a “Recently Talked About” widget identifies and illustrates items that have been recently been discussed by a user and/or members of a community or group. In this context, “recently” is a configurable metric definable to include posts tagged with one or more topics which have been discussed within the past hour, day, week, or even months or years. The technology provides a snapshot of those topics that are currently important or trending. On fast moving message boards and user, community, and group pages, presenting this information in a convenient visual format can quickly give users a summary and tone of discussions without having to read a large number of posts.

In one implementation, the RTA widget includes a time-decayed algorithm that analyzes the frequency of a user's posts and comments for a variety of topics. The time period for analysis can be customizable, but in one implementation, is two months. Other signals contemplated by the RTA algorithm may include instances in which a user's post is validated by another user as being authoritative on a topic, for example by liking or re-sharing the post. In this way, the original author of the post receives credit for being knowledgeable in those topics for which the post is tagged.

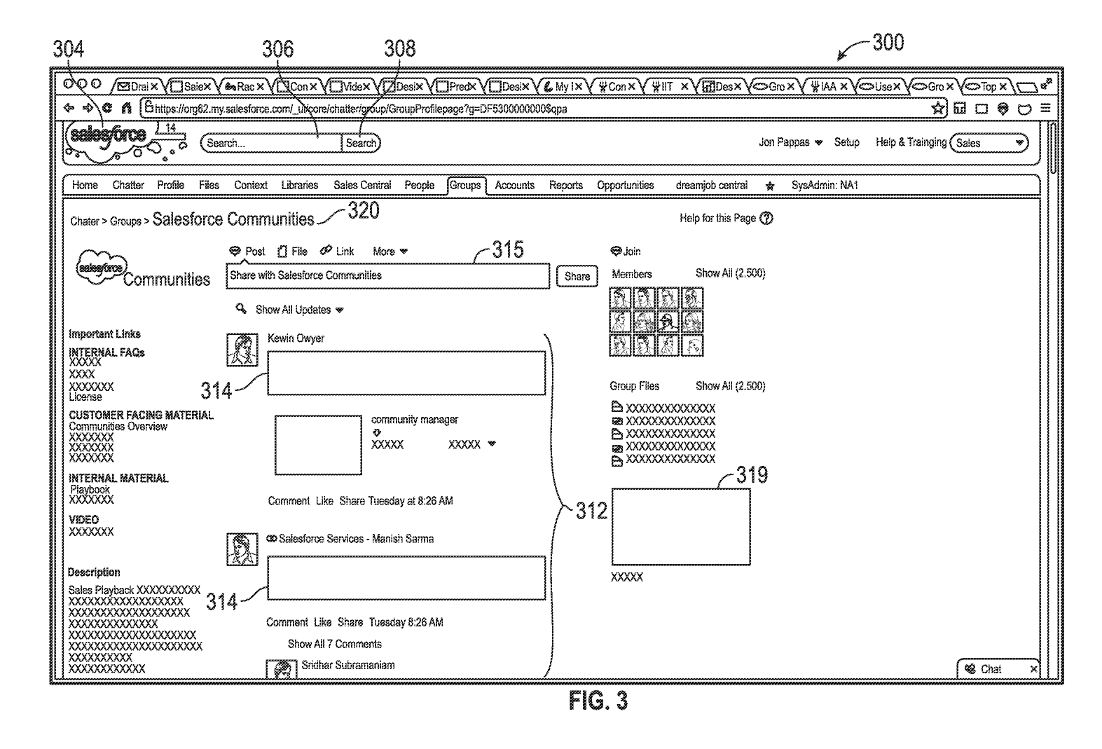

Referring now to FIG. 3, a group or user page 300 includes an organization field 304, a search box 306 and virtual button 308, a user/group name 320, a feed 312 including one or more feed items (posts) 314, a publisher 315, and an RTA display 319 including a list of topics recently discussed by the user or group 320. The manner in which these topics are identified and scored will now be described.

Topics recently talked about by a user or group may be determined based on a variety of metrics. For example, “points” may be credited to topics and tracked on an index table: i) when a user creates a post and tags it with a topic (e.g., by embedding a hashtag in the text of the post); ii) when another user (not the author) tags a topic to the post; and/or iii) when a user (not the author) responds to or comments on a tagged post (which is analogous to authoring a post). Tagging a post with a topic also causes that post to be displayed in the feed of the tagged topic page. Each time a post gets tagged with another topic (either by the author or another user), the post gets another point. Publishing or responding to an untagged post is not detected by the RTA scoring algorithm in a preferred embodiment (except possibly contextually, as discussed below).

In an embodiment, the RTA widget may also be configured to expose the ranked RTA topics in an RTA display 319 on group and/or user pages, for example by persisting and displaying the top N ranked topics, where N is a configurable number such as 3, 5, 10, 20, or the like. In addition, the RTA data may be used to populate and expose lists on each topic's page which include the top groups/knowledgeable users that talked about that topic. Stated another way, the RTA index table may be used to populate and display trending topics on group/user pages, whereas “trending” groups and knowledgeable users may be displayed on topic pages. Topic pages may also be configured to expose experts in a “knowledgeable people” display 217 (See FIG. 2), using a more rigorous experting algorithm as discussed in greater detail below.

The RTA algorithm may also employ a time decay component, whereby points attributable to a topic drops off after a configurable time period such as, for example, predetermined number of days, weeks, or months (e.g., two months). Thus, it can be said that the RTA topics are displayed according to their scores determined in accordance with the foregoing frequency and recency metrics, which may be weighted as further described below.

Alternatively, a post may be accorded RTA credit based on the context or location in which it was generated (also referred to as its container of origin). For example, an untagged post composed within a particular community, business object, topic page, or group page (e.g., “coffee lovers”) may be considered a candidate for being tagged with the topic coffee, even though not formally tagged as such. That is, the system can attribute an implied topic to a post based on the context in which it was posted, and thereby award a weighted “point” to the post resulting from the contextually implied tag.

### Suggesting Post Topics

When a user publishes an untagged post in the user's own feed, viewership is typically limited to that user's followers. To enhance distribution and increase the likelihood of getting a meaningful response, the system may suggests topics to tag so that the post gets directed to the tagged topic pages. Presently known systems present the user with a static list of predefined topics, which may or may not be applicable to the then current post. By presenting topics to the author of the post in real time, the accuracy of the topic-to-post relationship may be increased, as well as the frequency with which posts are tagged. Moreover, by liberally tagging posts, users maintain a living file system for their posts, organized by topic, thereby facilitating a tagging culture.

In an embodiment, users tag their posts with topics to thereby associate the post with one or more topics (e.g., by using hash tags within the body of the post). Systems and methods provide users with the seamless experience of tagging their posts and feeds with automatically suggested topics based on: i) the particular user's affinity for various topics; and/or ii) the affinity of the context of the post (group, object, location) for various topics. The systems and methods disclosed herein can further recommend groups for users to join based on users' topics of interests and identify general topics and trending topics tailored to the individual user.

Systems and methods are provided for suggesting topics for users to classify generated data, i.e., when a user has a post or a question, the system suggests topics related to the post that the user can tag the post with. More particularly, the technology relates to suggesting topics to users to tag their posts in social networks such as Facebook and Twitter based on affinity, context of the posts, and other factors.

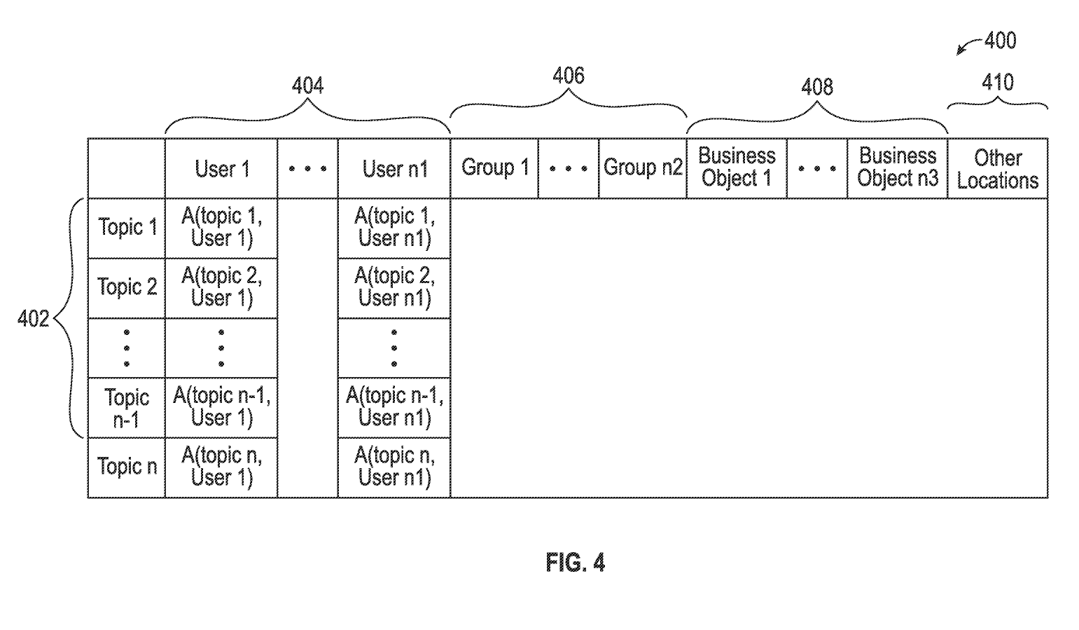

Referring now to FIG. 4, each user or group's affinity for various topics may be determined by recording affinity data, such as interactions, comments, posts, and/or tags, in an affinity table 400. More particularly, affinity table 400 associates a plurality of topics 402 with various users 404, groups 406, business objects 408, and other locations 410. For example, when a user tags a post with a topic (e.g., “Stockholm”, “Coffee”), the user-to-topic index in the affinity table is updated (e.g., in real time) to reflect this particular user's affinity for this particular topic. Based on the information stored in the affinity table, specific topics may be suggested to users as they post that are related to the user's affinity for the various topics. In this way, a system can automatically suggest topics to tag to a post that are individually-tailored to each user.

Thus, user affinity, group affinity, business object affinity, and location affinity can be recorded in affinity table 400. Whenever a user tags a post that is associated with one or more groups, business objects, and locations with a topic, the user-to-topic index, the group-to-topic index, the business object-to-topic index, the location-to-topic index in the affinity table may be updated to reflect the affinity of the user, group(s), business object(s), location(s) for this particular topic. This implementation allows the system to automatically suggest post topics that are individually-tailored to each user for the group(s) and business object(s) associated with the post created at one or more location(s).

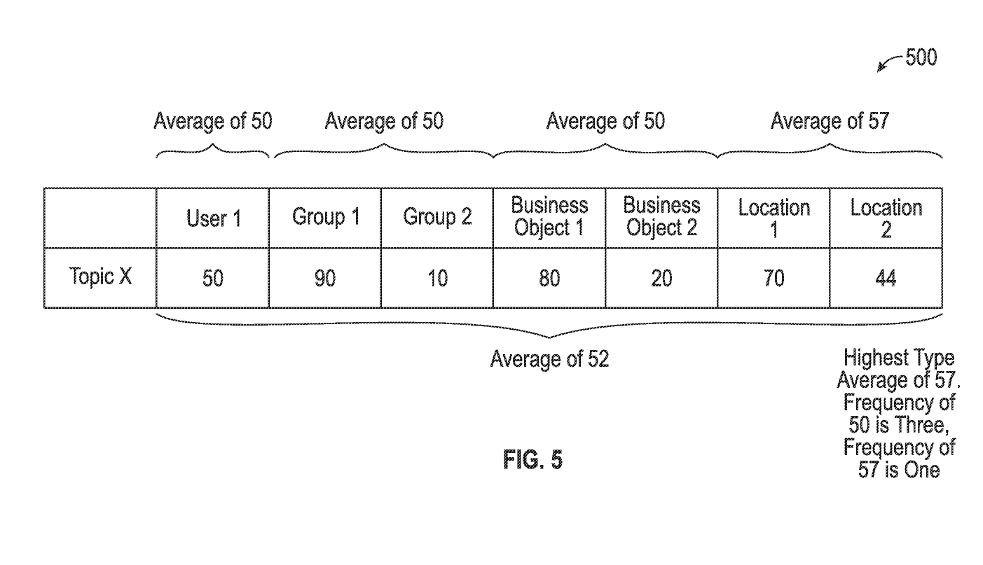

By way of illustration and referring now to the affinity table 500 shown in FIG. 5, user 1 can create a post associated with groups 1 and groups 2, business objects 1 and 2, and locations 1 and 2. User 1's affinity for a topic X is 50. The affinities of groups 1 and groups 2 for topic X are 90 and 20, respectively. The affinities of business objects 1 and 2 for topic X are 80 and 20, respectively. The affinities of locations 1 and 2 for topic X are 70 and 44, respectively. Topics may be suggested based on the highest possible affinity of a topic, which is 90 (i.e., the affinity of group 1 for topic X). Topic suggestions may also be based on the average affinity of a topic, which is 52 for topic X calculated from the average of 50, 90, 10, 80, 20, 70, and 44. Topic suggestions may further be based on the highest type average of a topic, which is 57 for topic X calculated from the maximum of (50, average of 90 and 10, average of 80 and 20, average of 70 and 44).

Alternatively and with continued reference to FIG. 5, a candidate topic may also be suggested if the minimum affinity of the topic is higher than a certain threshold. For topic X, if the threshold is not greater than 10, the system will not suggest topic X because the lowest affinity for topic X is 10 based on the affinity of group 2 for topic X. A candidate topic may also be suggested if the frequency of type average is not greater than a certain threshold. For topic X, if the threshold frequency of type average of 57 is twice, the system will not suggest topic X because the frequency of type average of 57 is once.

In another implementation, suggested post topics may be based on the aggregate affinity of a topic. The aggregate affinity can be calculated with different weights assigned to the user type, the group type, the business object type, and the location type. For example, user 1 can create a post associated with group 1 and business objects 1 and 2 at locations 1, 2, and 3. The aggregate affinity can be the sum of user 1's affinity adjusted by user_weight, group 1's affinity adjusted by group_weight, the average affinity of business objects 1 and 2 adjusted by business_object_weight, and the average affinity of locations 1, 2, and 3 adjusted by location_weight, i.e. aggregate_affinity=user_weight*user_{—}1_affinity+group_weight*group_{—}1_affinity+business_object_weight*(1/2*(business_object_{—}1_affinity+business_object_{—}2_affinity))+location_weight*(1/3*(location_{—}1_affinity+location_{—}2_affinity+location_{—}3_affinity).

In another implementation, post topics may be suggested based on the aggregate affinity of a topic. The aggregate affinity can be calculated with different weights assigned to different users, groups, business objects, and locations. For example, user 1 can create a post associated with group 1 and business objects 1 and 2 at locations 1, 2, and 3. The aggregate affinity can be the sum of user 1's affinity adjusted by user_{—}1_weight, group 1's affinity adjusted by group_{—}1_weight, the affinity of business objects 1 adjusted by business_object_{—}1_weight, the affinity of business objects 2 adjusted by business_object_{—}2_weight, the affinity of locations 1 adjusted by location_{—}1_weight, the affinity of locations 2 adjusted by location_{—}2_weight, and the affinity of locations 3 adjusted by location_{—}3_weight i.e. aggregate_affinity=user_{—}1_weight*user_{—}1_affinity+group_{—}1_weight*group_{—}1_affinity+(business_object_{—}1_weight*business_object_{—}1_affinity+business_object_{—}2_weight*business_object_{—}2_affinity+business_object_{—}3_weight*business_object_{—}3_affinity)+(location_{—}1_weight*location_{—}1_affinity+location_{—}2_weight*location_{—}2_affinity+location_{—}3_weight*location_{—}3_affinity).

In another implementation, correct weightings may be determined for the different types of topics. For instance, initial weights may be assigned for different types and thereafter tracked. The technology can increment the weights of the successful types. Specifically, it can calculate the frequency of the suggested topics based on the types. Furthermore, it can calculate how often a user has accepted suggested topics, meaning that the suggestion was successful. Using that information, the technology can increment the weighting for a type that is above the average and decrement the weighting for any type that is below the average. This can be done automatically or manually.

In another implementation, the affinity of users, groups, business objects, and locations for various topics may be calculated using a time-inflated method such that the recent tags of posts are given higher weight than tags that are more remote in time. This inflation system makes older topic tags less valuable than current topic tags in calculating the affinity and allows topic suggestions to be based more on the recent interests and the affinity of the context. An example of the inflation factor when a post is tagged with a topic at time t is 2̂((t−t0)/h), where t0 is the starting date at which time the increment will be 1 and h is the affinity score half-life measured, for example, in days. The further one goes into the future, the more each tagging of the post topic is worth. A topic tag h days in the past will be worth half as much as a topic tag today.

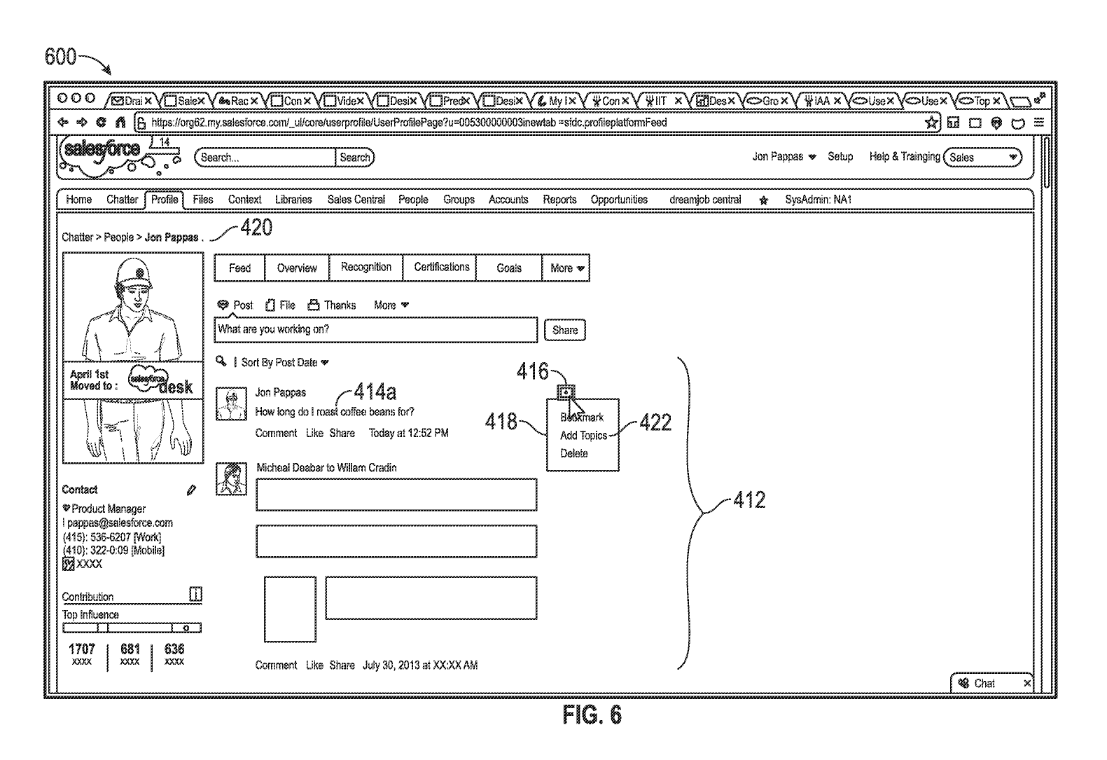

Referring now to FIGS. 6-9, an exemplary manner in which topics are suggested will now be illustrated in the context of a user page. More particularly and with specific reference to FIG. 6, a screen shot 600 shows a user page for a user 420 including a feed 412 having a plurality of feed items including a post 414A. in the illustrated example, the post 414A is in the form of a question “How long do I roast coffee beans for?” By selecting (e.g., clicking on) an options button 416, a drop down menu 418 is displayed. Selecting the “Add Topics” virtual button 422 invokes the topic suggestion widget.

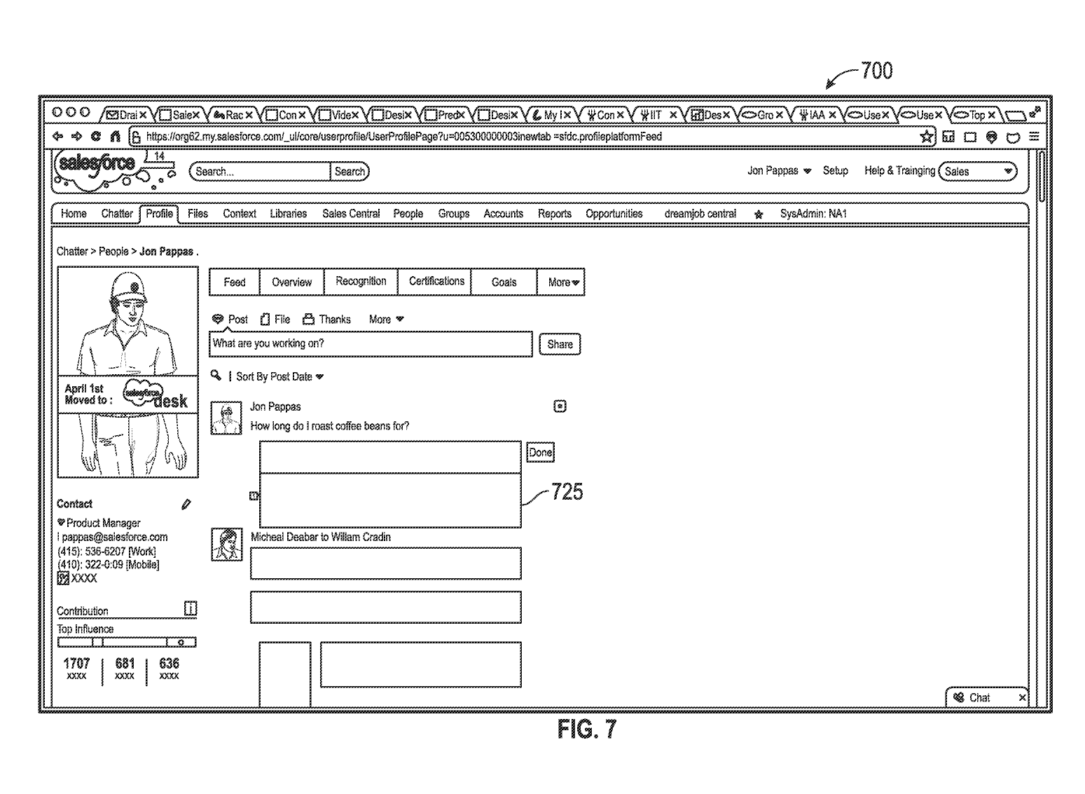

FIG. 7 is a screen shot 700 including a drop down menu 725 of suggested topic presented to the user. In the illustrated example, the topics “Coffee Beans” and “Coffee” are suggested based on key words identified in the post text. By selecting one (or both) of the suggested topics, the then current post will be tagged with the selected topic(s).

In addition to the foregoing key word searching, natural language techniques may be employed based on the text of the post to identify names, places, things, people, and the like to be presented as proposed topics “on the fly”; that is, key word searching does not identify any matching topics from the then current topics database, natural language techniques may be employed to suggest new topics which are not currently in the topics database. If a user selects one of the proposed topics, it is added to the topics database and a topic page may be created for the newly added topic.

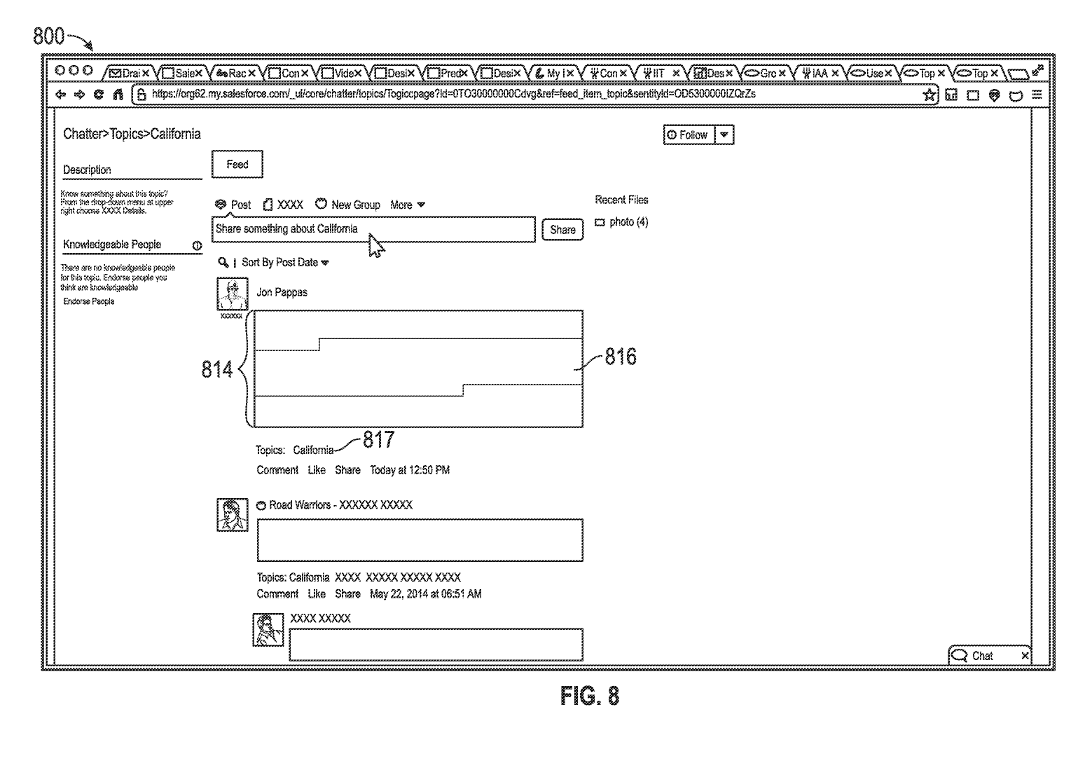

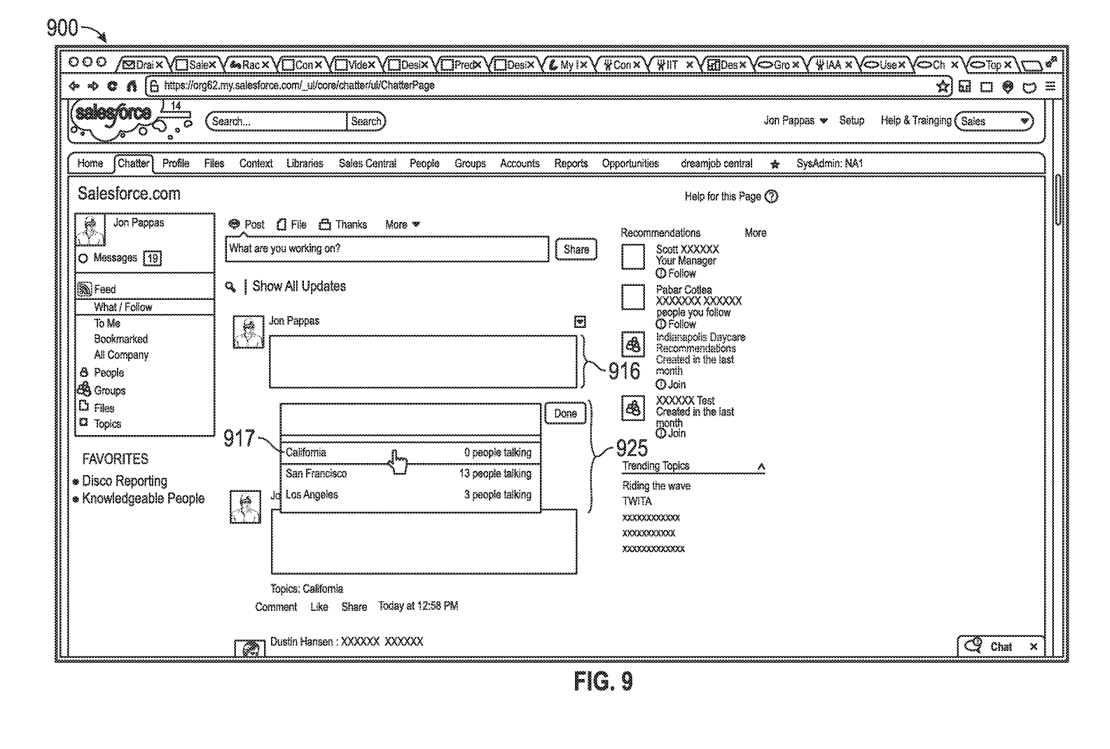

In an embodiment, a table may be maintained which maps words and phrases to topics, so that the next time a user uses an existing phrase while composing a post, the topic that a previous user selected for the same phrase will be suggested as a topic (even if the text being composed does not contain the topic word). FIG. 8 is a screen shot 800 showing a post 814 including a phrase 816. In the illustrated embodiment, the post 814 is tagged with a topic 817. As shown in the screen shot 900 of FIG. 9, when the same or another user includes the same phrase 916 in a post, a drop down menu 925 includes the suggested topic 917 based on the fact that the same phrase was previously included in a post tagged with topic 917.

In an embodiment topics may be suggested using a suggestion algorithm which considers the frequency with which a topic is recorded as being associated with a user, group, or the like, as well as recency of those associations. Based on frequency and recency considerations, either all or a sub-set of existing topics may be exposed to the user as topic suggestions. In various embodiments, the top 1, 3, 5, or 10 matching topics may be presented. The topic suggestion engine may be configured to manifest suggested topics in a drop down menu, either automatically while composing, or in response to clicking an ‘add topics’ virtual button.

Although the foregoing topic suggestion feature is discussed in the context of posts, it will be appreciated that topics may also be suggested for tagging to business objects such as records (e.g., opportunities, contacts). Hence, an affinity table may be maintained for mapping topics to users, groups, locations, and other objects. That is, just as a group can be the container in which the post is created, so too any object can be the container (location) from which or within which the post is created. That is, the affinity between the topic and the business object may arise contextually.

### Two Stage Protocol for Qualifying Experts

Experts may be identified and confirmed based on the frequency with which a knowledgeable person's or candidate influencer's posts are ratified by other users. Various metrics may be used to score a candidate influencer's expertise, such as the number of times a person's posts are “liked”, @mentioned, re-shared, or otherwise recognized by others. Candidate influencers' scores may be maintained in an affinity index, analogous to the data tables discussed above. In addition to the foregoing algorithmic component, a second “human” component may be used to enhance the reliability of an expert designation, such as an unambiguous endorsement from another user.

In one implementation, candidate influencers or experts on topics may be identified based on the frequency they are @mentioned on a topic. The underlying rationale surrounds the notion if another user regards a post highly enough to recommend (e.g., @mention) it to a group, the author of the post should be credited with having knowledge in the subject matter of the @mentioned post. Analogously, tagging the post with a topic suggests that the tagger regards the poster as being knowledgeable in the tagged topic.

Candidate influencers identified in this way (i.e., algorithmically) may be verified by a second, non-algorithmic human component, for example, another user's endorsement. A user can endorse a candidate influencer as an expert, for example, by clicking the “like” icon next to each topic on the candidate influencer's profile page, or by clicking the candidate influencer's like icon on a topic page. That is, another user can either “like” the topics for which a candidate influencer is knowledgeable, or “like” the candidate influencer for a particular topic. This manual endorsement step may be used to verify that this candidate influencer is indeed an expert. This two-step identification-verification process is more reliable than either step alone.

Candidate influencers or experts may also be algorithmically identified based on the frequency their comments on a topic are favorably acknowledged, for example, liked by others. Similarly, candidate influencers may be algorithmically identified based on the frequency their posts on a topic are favorably acknowledged by being re-shared, re-tweeted, or otherwise republished with implicit or explicit approval of the republished subject matter. Again, the underlying rationale surrounds the notion that if another user goes to the trouble to “like”, re-share, re-tweet, or otherwise republish a post, the author of the post should be credited with being knowledgeable in the republished subject matter.

In another embodiment, candidate influencers or experts may be algorithmically identified on topics based on the aggregate frequency. In this context, a candidate influencer's aggregate frequency for a topic is the sum of the frequency s/he is @mentioned on the topic, the frequency his/her comments on the topic are liked, and the frequency his/her posts on the topic are re-shared. In addition, different frequency components may be adjusted by different weights. A user's aggregate frequency for a topic may thus be expressed as: aggregate_frequency_topic_{—}1=@mentioned_weight*@mentioned_topic_{—}1_frequency+comments_liked_weight*comments_topic_{—}1_liked_frequency+posts_reshared_weight*posts_topic_{—}1_reshared_frequency. In the previous example, the same @mentioned weighting factor is applied to all topics @mentioned. In another example, different @mentioned, like, and re-share weighting factors may be applied on a topic by topic basis.

In a further embodiment, each frequency component may be adjusted by a weight component with the same frequency components of different topics being adjusted by different weights. A user's aggregate frequency of a topic may thus be expressed as: aggregate_frequency_topic_{—}1=@mentioned_topic_{—}1_weight*@mentioned_topic_{—}1_frequency+comments_topic_{—}1_liked_weight*comments_topic_{—}1_liked_frequency+posts_topic_{—}1_reshared_weight*post_topic_{—}1s_reshared_frequency.

In another embodiment, for two of @mention, like, and re-share, a single initial weight may be assigned, with two initial weights assigned to the remaining component frequency. The system can then select the better weight for the remaining component frequency and iterate. Specifically, it can calculate the different frequency of the candidate influencers being endorsed depending on the different weights of the remaining component frequency used in the calculation of aggregate frequency. The system can then iterate to determine a better weight for the remaining component frequency or to determine a better weight for the other two component frequencies. Weight adjustment can be done automatically or manually. This learning algorithm ensures that candidate influencers identified are indeed good candidates. In another implementation, the technology disclosed can set different correct weights for different topics.

In another embodiment, candidate influencers or experts on topics may be identified based on a time-inflated system. The frequency will be adjusted based on when an event occurs. An event can be when a user is @mentioned on a topic, when comments on a topic are liked, and when posts are re-shared. An example of the inflation factor when a user is @mentioned on a topic at time t is 2̂((t−t0)/h), where t0 is the starting date when the inflation factor is 1 and h is the half-life of points expressed, for example, in days. An event h days in the past is worth half as much as an event today. The further into the future, the more each event is worth in calculating the aggregate frequency. This makes older events less valuable than current events, and candidate influencers who are recently @mentioned and whose comments are liked and posts re-shared are recommended first.

In a further embodiment, candidate influencers may be verified (the non-algorithmic human component) by taking into consideration like, dislike, and no opinion metrics from other user's. That is, a user can endorse a candidate influencer, for example, by clicking the like icon next to each topic on the influencer's or the expert's profile page or by clicking the like icon next to each influencer's or the expert's icon on the topic page. In this example, a user can also express disapproval of a candidate influencer by clicking the dislike icon or otherwise registering dis-satisfaction with a candidate influencer's expertise. A user can also decide not to click on either the like or the dislike icons, for example, when the user has no opinion on the candidate influencer's answer or other post.

A candidate influencer may be endorsed when his/her endorsement score is above a certain threshold. The endorsement score can be calculated, for example, from the sum of the frequency of like adjusted by some weight, the frequency of dislike adjusted by some weight, and the frequency of no opinion adjusted by some weight, i.e., endorsement score=like_weight*like_frequency+dislike_weight*dislike_frequency+no_opinion_weight*no_opinion_frequency. In another implementation, the technology disclosed herein can set correct weights for like, dislike, and no opinion. In another implementation, the technology disclosed can calculate the endorsement score using on a time-inflated system.

The following illustrative example incorporates various aspects of the previous embodiments as well as additional features. User Jane creates a post, which can be a record or feed item. The record or feed item Jane creates can be a question posed in a social network about traveling to Stockholm. Any post can have one or more topics associated with it. The one or more topics of a post can be manually tagged by one or more users or automatically tagged, as discussed infra. The tag can be user-defined, pre-defined, or generated automatically. In the current example, user Bob tags Jane's post about traveling to Stockholm with the topic “Stockholm”. In the implementation, user Joel answers the question. Joel's comment is liked by Jane, which is one of the algorithmic signals described above which indicates that Joel is a candidate influencer. Alternatively or in addition, Joel is @mentioned on a topic about “Stockholm”, which is another algorithmic signal indicating Joel is a candidate influencer.

Alternatively or in addition, Joel's post about “Stockholm” is re-shared, which is another algorithmic signal indicating that Joel is a candidate influencer. Based on one or more algorithmic signals, which may include the three algorithmic signals mentioned above, the “Stockholm” topic page exposes Joel as a candidate influencer or an expert. Alternatively or in addition, Joel's profile page shows that he is a candidate influencer or an expert on the “Stockholm” topic page. Users can endorse candidate influencers and experts and thereby confirm that candidate influencers are indeed experts on the topics. In this example, user Tina, who knows Joel to be an expert on Stockholm, endorses Joel as an expert on Stockholm. Tina's endorsement confirms that Joel is indeed an expert on the city of Stockholm. Tina can endorse Joel as an expert on Stockholm by clicking the like icon next to the topic Stockholm on Joel's profile page, or by clicking the like icon next to Joel's icon on the “Stockholm” topic page.

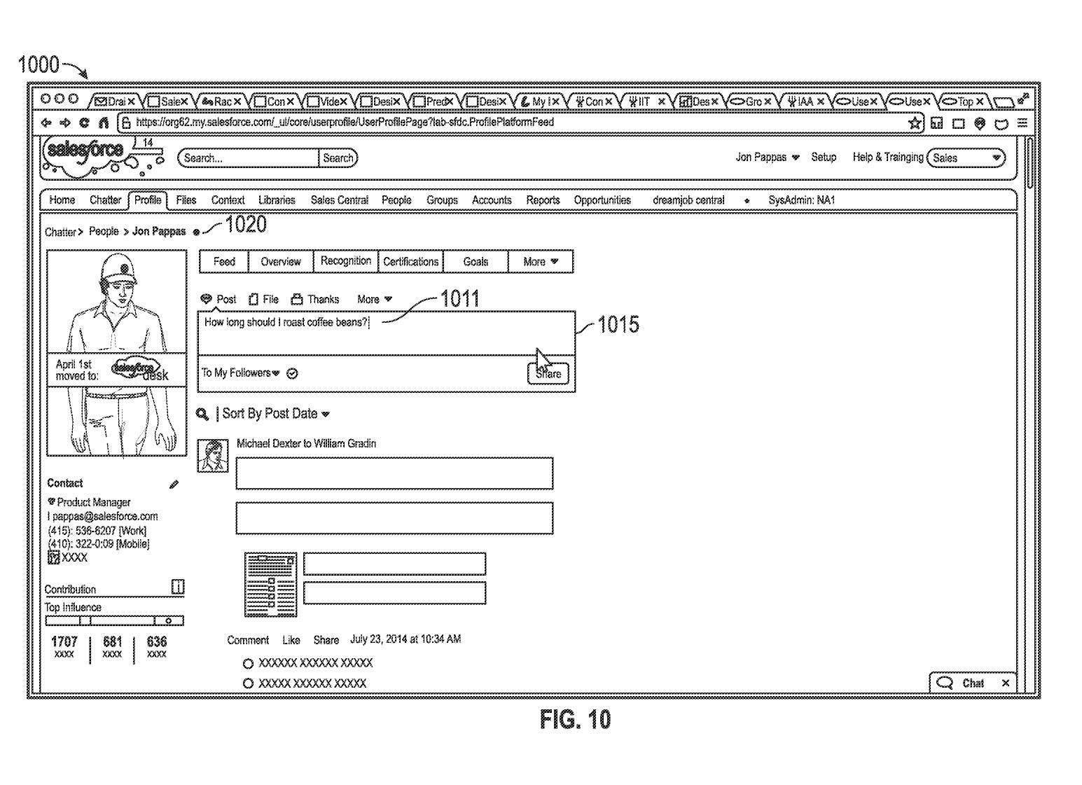

Referring now to FIGS. 10-15, various examples by which an expert may be qualified will now be described.

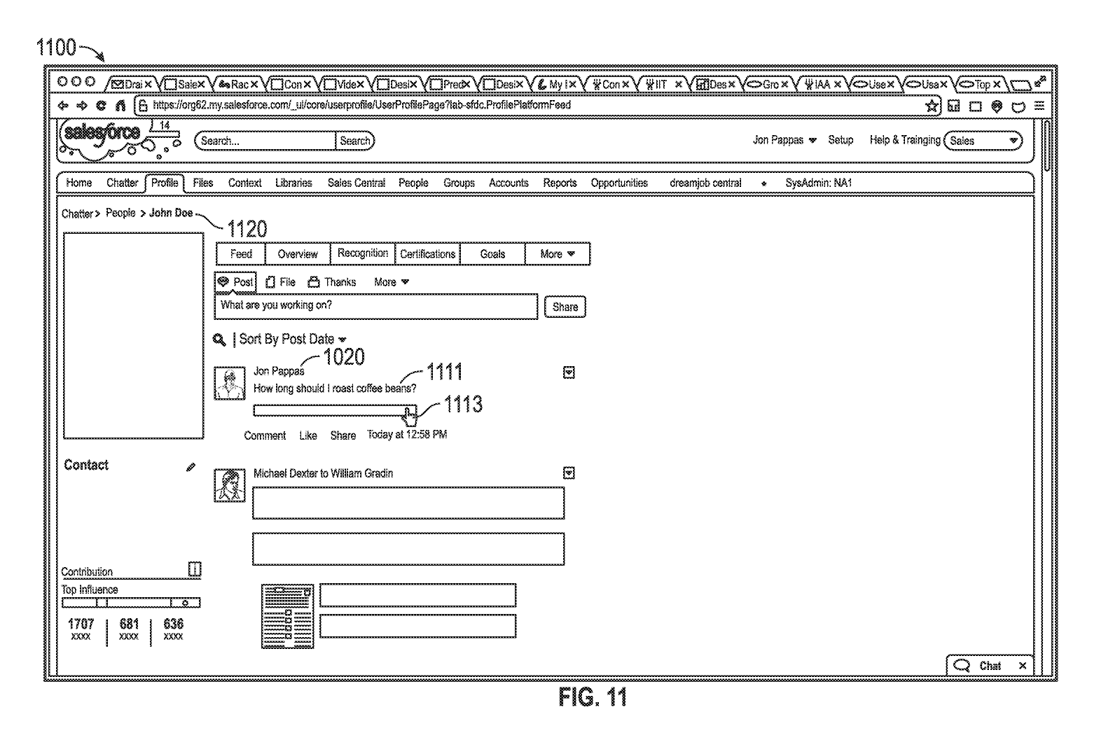

FIG. 10 is a screen shot of a user page 1000 illustrating a user 1020 posting a question 1011 from a publisher 1015. FIG. 11 is a screen shot of another user's page 1100 illustrating that other user 1120 tagging a post 1111 with a topic 1113. In so doing, the author 1020 of the post receives credit as a candidate influencer for the topic 1113.

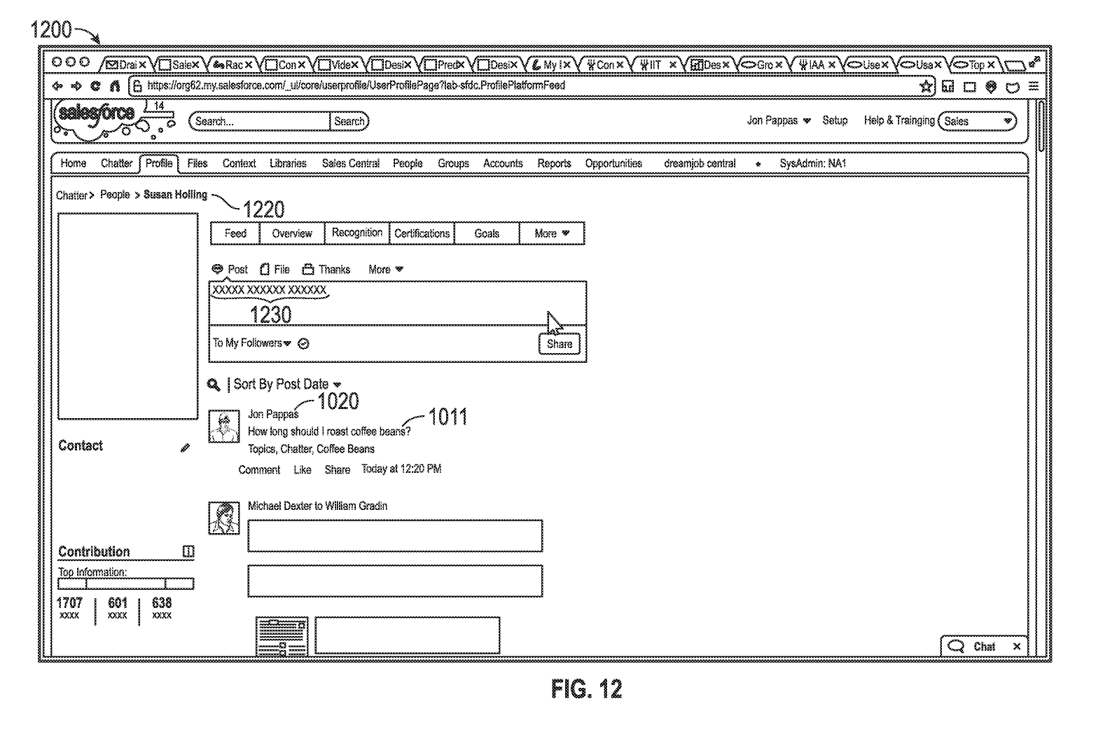

FIG. 12 is a screen shot of a user page 1200 illustrating a user 1220 recommending the original post 1011 to a group by @mentioning 1230 the post to the “Canadian Employees” group. As a result, the original author 1020 of the post receives credit as a candidate influencer for all topics tagged to the @mentioned post.

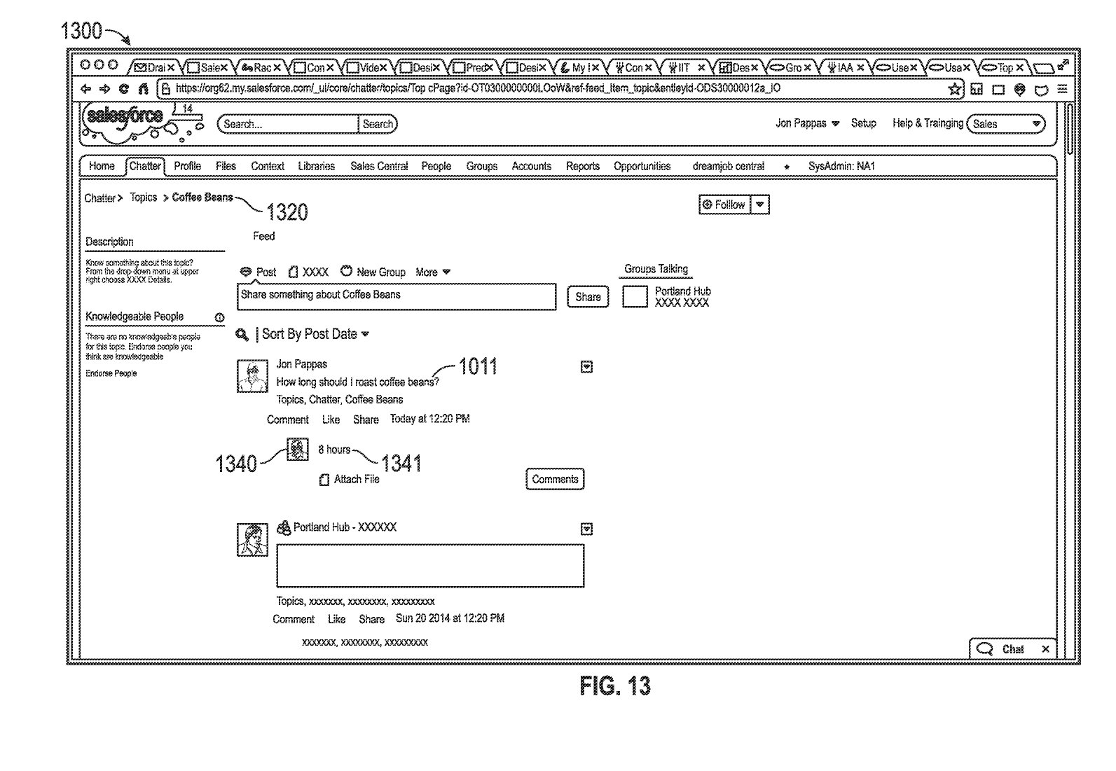

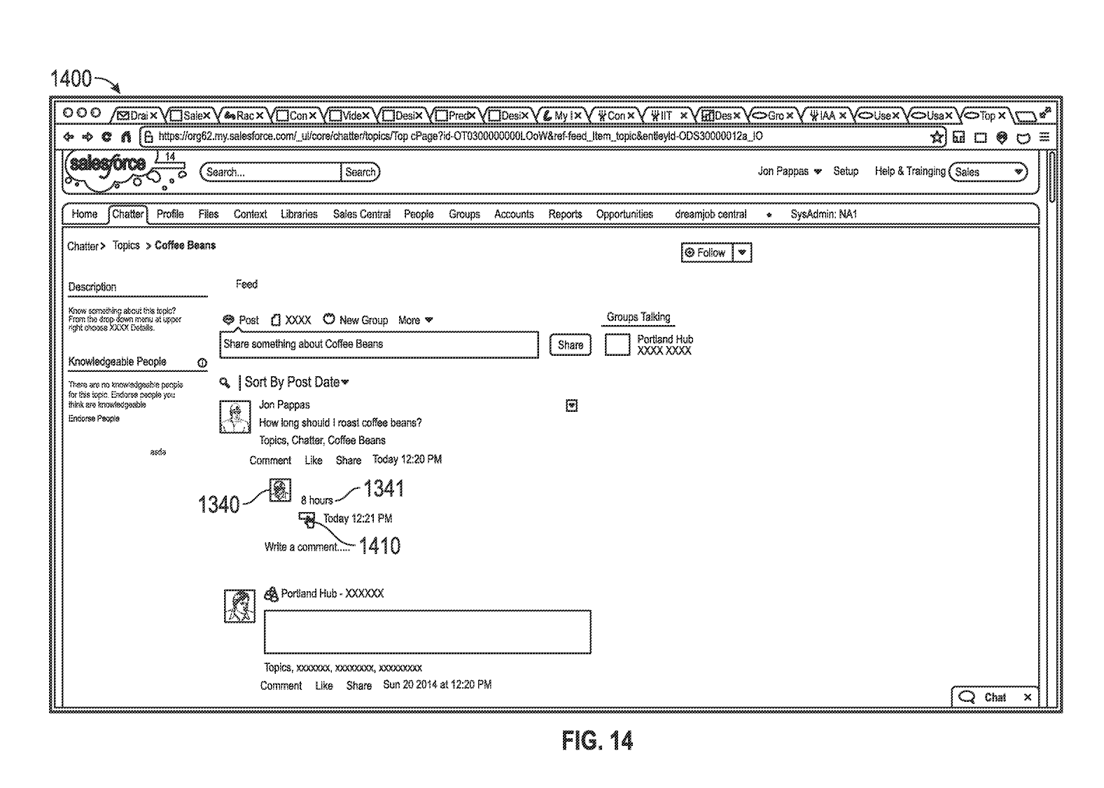

FIG. 13 is a screen shot of a topic page 1300 for the topic 1320 (“Coffee Beans”) illustrating a candidate influencer 1340 posting an answer 1341 to the original question 1011. FIG. 14 is a screen shot of a topic page 1400 illustrating another user indicating agreement or otherwise ratifying candidate influencer's 1340 answer 1341, for example by liking 1410 the answer. In this way, candidate influencer 1340 receives credit as a candidate influencer for all topics tagged to the liked post.

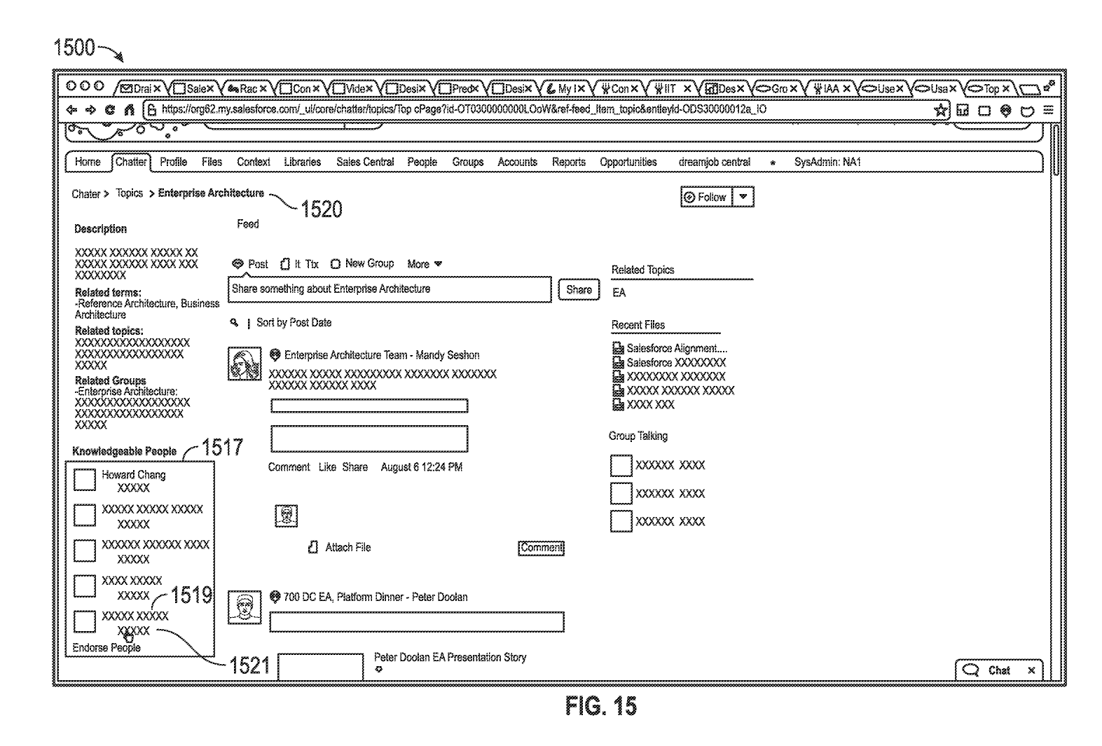

FIG. 15 is a screen shot of a topic page 1500 for the topic 1520 (“Enterprise Architecture”) illustrating the second, non-algorithmic component of expert qualification, namely, human endorsement. More particularly, the topic page 1500 includes a Knowledgeable People display 1517 listing a plurality of candidate influencers. By manually clicking the “Endorse” virtual button 1521 associated with a particular candidate influencer 1519, that candidate influencer may be unambiguously qualified as an expert.

In the previous examples, posts were treated generically without regard to whether the post is intended to be a question. In an embodiment, natural language techniques may be employed to identify posts which are intended to be questions and treat them accordingly. In addition, a post may be specifically designated as a question thereby invoking a rules engine which formats and presents the post as a question, recommends experts, and tallies correct and incorrect answers. Specifically, a post which is specifically designated as or otherwise determined to be a question may be presented in a feed with an ‘answer’ button instead of a ‘comment’ button. In this regard, merely commenting on a post can support a user's score as a knowledgeable person, but not as an expert. Answering a question, on the other hand, can support a candidate influencer's expertise, as discussed in greater detail below.

### Identifying Experts Based on Correct and Incorrect Answers

In another embodiment, topical experts may be identified within a Q&A community based on answers to questions posed by members of the community. Points are awarded and tracked on a leaderboard based on correct and incorrect answers, with weights assigned to positive and negative points.

In on-line Q & A communities, posts are typically formatted as questions, and answers to the questions are typically accompanied by vote up/down virtual buttons, as opposed to the “like” button typically associated with comments on topic, group, and user pages. Members of the Q & A community use the up/down virtual buttons to register their agreement or disagreement with an answer, resulting in a community consensus on the correctness of the answer as well as the expertise of the user who provided the answer.

Various metrics associated with knowledgeable people may be gathered from Q & A (also known as forum) pages, and maintained in an affinity index or other database table, as described in detail above. When knowledgeable people are identified on Q & A pages and elsewhere using the techniques described below, a suitable widget can populate the identified experts as desired, for example, onto topic pages.

User engagement may be enhanced by automatically identifying users who are experts on various topics in a social networking environment. In one implementation, a user can be classified as an expert in a particular topic when the user has correctly answered questions associated with that topic. An answer can be classified as correct based on the feedback of the person asking the question, or the community's consent. Another way a user can become classified as an expert on a particular topic is based on the frequency of being @mentioned on the topic, the number of times his comment is liked, how frequently his post on the topic is shared, how often an answer is followed by an endorsement, etc. Additionally, in one or more implementations, as noted above, the systems and methods can suggest topics for posts and questions automatically to seamlessly connect users who have questions with experts who have answers and thus improve user engagement.

The systems and methods disclosed herein can further recommend groups for users to join based on users' topics of interests and identify general topics and trending topics tailored to the individual user.

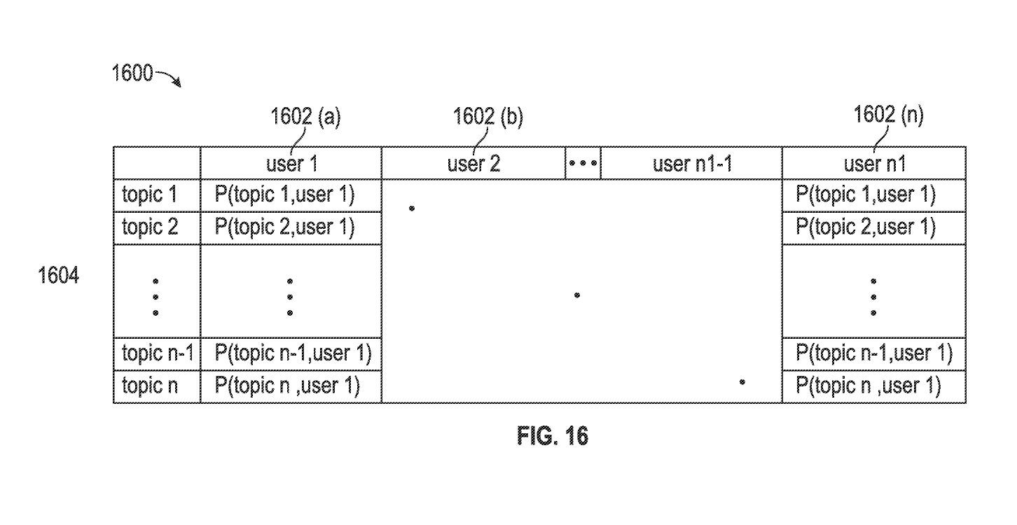

Users who are experts in particular topics may be identified based on the history of these users having previously correctly answered questions, for example, in the context of Q & A pages. In one implementation, when a user answers a question, this user is considered to have knowledge about each topic associated (e.g., tagged) with that question. When a user answers a question correctly, the user is awarded points for each topic associated with the question. The number of points a user has for various topics can be tracked, for example, by an expertise table of the type generally described below in connection with FIG. 16.

The correctness of an answer can be determined based on the feedback of the person asking the question. The correctness of an answer can also be based on the Q & A community's consent. The more total points a user has for a particular topic, the more knowledge this user is deemed to have about that topic, for which the user can then be classified as an expert. One implementation allows the system to automatically identify experts of particular topics by recording a user's history of having answered questions correctly.

In another implementation, users who are experts of particular topics may be identified by taking into consideration these users' previous correct and incorrect answers to questions related to the topics. When a user answers a question correctly, that user's total points for each of the topics associated with the question may increase. When a user answers a question incorrectly, this user's total points for each of the topics associated with the question may be reduced. The more total points a user has for a particular topic, the more knowledge this user has about this particular topic and this user can then be classified as an expert of this particular topic. This implementation allows the system to automatically identify experts of particular topics while taking into account the impact of both correct and incorrect answers.

In another implementation, experts may be identified by considering previous correct and incorrect answers and the weighing correct and incorrect answers differently. When a user answers a question correctly, the user's positive points for each of the topics associated with the question increase. When a user answers a question incorrectly, the user's negative points for each of the topics associated with the question increase. The positive and negative points for a particular topic can be weighed differently in the calculation of the total points a user has for this particular topic in the following manner: total_points=weight_positive_points*positive_points+weight_negative_points*negative_points. The more total points a user has for a particular topic, the more knowledge this user has about this particular topic and this user can then be classified as an expert of this particular topic. This implementation allows the system to automatically identify experts of particular topics while taking into account both correct and incorrect answers and considering the weighted impact of correct and incorrect answers differently.

In another implementation, correct and incorrect answers of different topics may be weighted differently; that is, the positive and negative points for different topics can have different weights. The positive and negative points of different topics can also have different weights in the calculation of the total points a user has for different topics, i.e., total_pointstopic_{—}1=weight_positive_pointstopic_{—}1*positive_pointstopic_{—}1+weight_negative_points_topic_{—}1*negative_points_topic_{—}1, and total_points_topic_{—}2=weight_positive_points_topic_{—}2*positive_points_topic_{—}2+weight_negative_points_topic_{—}2*negative_points_topic_{—}2, where weight_positive_points_topic_{—}1, weight_negative_points_topic_{—}1, weight_positive_points_topic_{—}2, and weight_negative_points_topic_{—}2 can have different values. The more total points a user has for a particular topic, the more knowledge this user has about this particular topic and this user can then be classified as an expert of this particular topic. This implementation allows the system to automatically identify experts of particular topics while taking into account the different impact of correct and incorrect answers on different topics.

In a further implementation, a user may be identified as an expert of a particular topic only if the user has not answered too many questions incorrectly. The positive and negative points for a particular topic can be weighed differently in the calculation of the total points a user has for this particular topic, i.e. total_points=weight_positive_points*positive_points+weight_negative_points*negative_points. The more total points a user has for a particular topic, the more knowledge this user has about this particular topic and this user can then be classified as an expert of this particular topic provided that this user has not answered questions related to the particular topic incorrectly too many times. This implementation allows the system to automatically identify experts of particular topics while taking into account the frequency of incorrect answers.

In another implementation, correct weights can be set for the positive points and negative points. The technology disclosed can assign initial weights for positive points and negative points and track them. It can also increase and decrease the weights of the positive points and negative points. Specifically, it can calculate the frequency of a recommended expert answering a question correctly and incorrectly. The technology disclosed can then increase or decrease the weights for positive points and negatives points depending on this frequency. This can be done automatically or manually.

In another implementation, the technology disclosed herein can set correct weights for the positive points and negative points of different topics. The technology disclosed can assign initial weights for positive and negative points of different topics and track them. It can also increase and decrease the positive and negative weights of a particular topic when a question related to this particular topic is answered correctly and vice versa. Specifically, it can calculate the frequency of the suggested experts answering questions related to various topics correctly and incorrectly. Furthermore, it can calculate the average frequency of suggested experts answering questions correctly and incorrectly in general. The technology disclosed can also increase the weight of any topic that is above the average and decrease the weight of any topic that is below the average. This can be done automatically or manually.

In another implementation, the technology disclosed herein classifies users as experts of particular topics based on a time-inflated system. The points for users who have answered questions correct and incorrectly will be adjusted based on when a question is answered. An example of the inflation factor when an expert answers a question at time t is 2̂((t−t0)/h), where t0 is the starting date when the inflation factor is 1 and h is the half-life of points in days. An answer h days in the past is worth half as much as an answer today. The further into the future, the more each answer is worth in calculating the total points. This makes older answers less valuable than current answers, and experts who have recently answered questions correct and are more likely to answer new questions have higher total points and are recommended first.

FIG. 16 is an expertise table 1600 which maps the number of points each of a plurality of users 1602 has accumulated for various topics 1604. Each time a user scores points or is otherwise awarded credit as described herein, the table 1600 may be updated, for example, in real time.

### Displaying Questions in the Feeds of Selected Experts

In a further embodiment, users having questions are connected with experts who have answers by identifying and suggesting experts for users to consider engaging for a particular question. Upon selecting one or more of the suggested experts, the system automatically notifies the selected experts by displaying the question in the expert's feed.

The technology disclosed herein can seamlessly connect users who have questions with experts who have answers and will promptly respond, thereby improving user engagement. It can achieve this improved user engagement by linking the technology for automatically suggesting topics with the technology for automatically identifying experts. Experts can be identified using the methods described in the previous section and other methods.

By way of illustrative example, user Wendy checks into a hotel and seeks recommendations on places to eat in Stockholm. User Wendy can create a post in a social network, which can be a record or feed item in the form of a question. Wendy's friend Tim tags her post with the topic “Stockholm”, and then selects a designated virtual button, icon, or the like (e.g., the @mention symbol) to reveal a list of all the experts on the city of Stockholm. By selecting one or more of the displayed experts, for example, by @mentioning them, the selected experts are notified and can promptly provide responsive recommendations.

In another implementation, for any post that has at least one topic, the system automatically notifies experts having expertise in the topic to answer the post. The technology disclosed notifies experts, for example, by displaying in the expert's feed questions for which they have expertise. In this embodiment, the experts may be solicited or notified without users explicitly selecting them.

In another implementation, a user may invoke an expert notification protocol, for example, by using the @ sign at any object or location associated with the post, whereupon the system displays top experts of those topics associated with the post. The user can select one or more of the suggested experts, who will be notified of their @mention.

In another implementation, whenever a user invokes the expert notification protocol, e.g., by typing the @ sign at any object or location associated with the post, a list of experts in the topic may be shown in a separate autocomplete section, for example, at or near the bottom of the page.

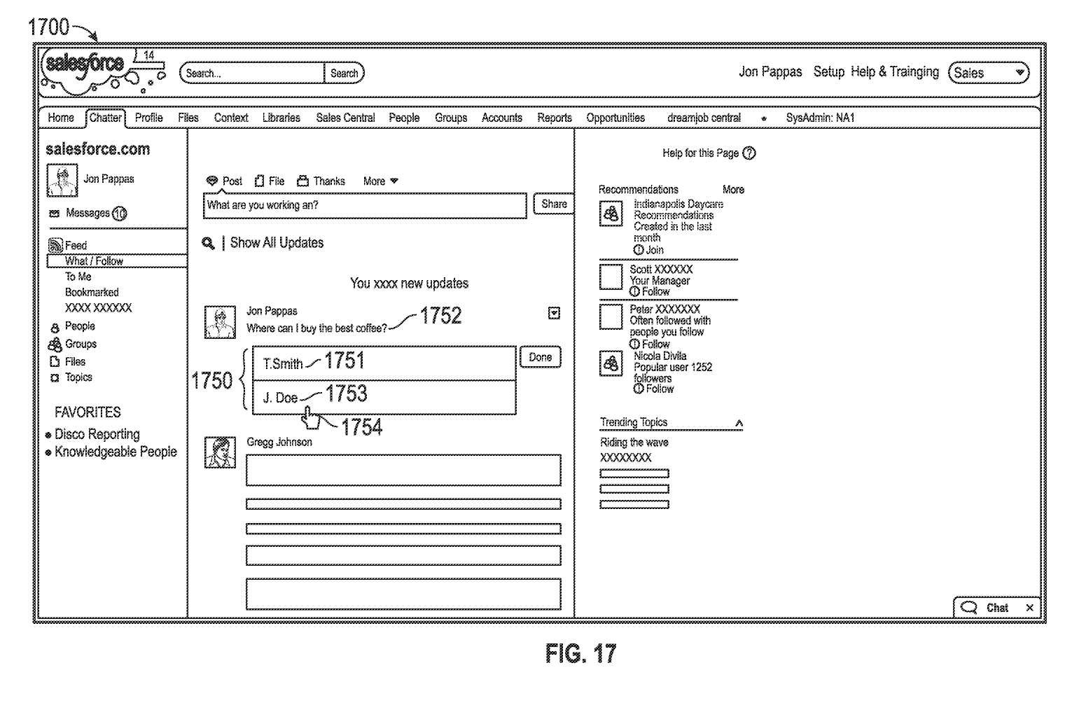

FIG. 17 is a screen shot of a user page 1700 showing a question 1752 and a drop down menu 1750 listing experts 1751 (“T. Smith”) and 1753 (“J. doe”) displayed in response to the user invoking the foregoing expert notification protocols. In the illustrated example, the user selects the expert 1753, for example, by clicking on it at 1754. Consequently, the question 1752 will be displayed in expert J. Doe's feed, thereby notifying the expert that he has been selected to answer the question.

A method is thus provided for qualifying a candidate as an expert on a topic in a database system computing environment. The method includes receiving at the database system, from computing devices at least temporarily associated with identified users, qualifying objects associated with the candidate indicating at least one of: i) the candidate has participated in a thread regarding a given topic; ii) the candidate has been identified in the thread regarding the topic; iii) a comment from the candidate has been favorably identified by a user; and iv) a comment from the candidate has been unfavorably identified by a user. The method further includes: evaluating according to a rule in the database system an expertise value based on at least one of the qualifying objects received during a time period; if the expertise value satisfies predetermined threshold, endorsing the candidate as an expert on the topic through at least one of: a first endorsement object indicating an expertise level for the topic on a page associated with the candidate; and a second endorsement object indicating an expertise level for the candidate on a page associated with the topic.

The method may also include providing a third object to link at least one of the users to the endorsed candidate based upon an assistance object received from the user, the assistance object including information indicating that the user could benefit from the assistance of a qualified expert on the topic.

In an embodiment, the time period is configurable by the user.

In an embodiment, evaluating comprises evaluating qualifying objects received during a time period comprising a predetermined number of days, weeks, or months.

In an embodiment, the qualifying objects comprise at least one of @mentioning, liking, and re-sharing a post authored by the candidate.

In an embodiment, the first endorsement object comprises a like icon on the candidate's user page, and the second endorsement object comprises a like icon on topic's page.

In an embodiment, evaluating the expertise value comprises maintaining an affinity index in the database system which maps a plurality of qualifying objects to a plurality of candidates.

The method may also include updating the affinity index upon selection of the first or second endorsement objects by a user, and presenting the thread in a social network feed.

In an embodiment, the predetermined threshold comprises a number of tracked qualifying objects in the range of 3 to 20.

In an embodiment, the assistance object comprises a post designated as a question.

In an embodiment, providing the third object comprises displaying a drop down menu listing qualified candidates.

The method may also include notifying the listed candidate in response to the user selecting one of the listed candidates.

In an embodiment, notifying comprises displaying a question in the selected candidate's feed.

A method is also provided for identifying and displaying current topics on a profile page in a social network. The method includes: maintaining in real time an index table in a database system which tracks, for each of a plurality of topics, the number of instances in which: i) an author of a post embeds indicia of the topic in the body of the post; ii) a user associates the topic with an existing post; iii) a user comments on a post associated with the topic; iv) a user responds to a post associated with the topic; v) a post associated with the topic is republished; and vi) a post associated with the topic is favorably identified by a user.

The method also includes: determining respective frequency scores for each of the plurality of topics based on the index table; determining respective time adjusted frequency scores for each of the plurality of topics based on the frequency scores and a time decay factor; identifying the top N time adjusted frequency scores, where N is in the range of three to twenty; and displaying indicia of N topics corresponding to the N time adjusted frequency scores on the profile page.

In an embodiment, displaying comprises exposing N topic names in a widget, and further wherein the profile page comprises at least one of a user profile page and a group profile page.

The method may also include determining respective user frequency scores for each of a plurality of users based on the index table; determining respective time adjusted user frequency scores for each of the plurality of users based on the user frequency scores and a time decay factor; identifying the top N time adjusted user frequency scores, where N is in the range of three to twenty; and displaying indicia of N users corresponding to the N time adjusted user frequency scores on each of a plurality of topic pages.

A method is also provided for automatically suggesting topics in a social network feed. The method includes: tracking the affinity of a plurality of topics to a plurality of locations; storing the tracked affinities in an affinity index; displaying suggested topics for a user to associate with a post user based on the affinity index; and updating the affinity index if the user associates the post with one of the suggested topics.

In an embodiment, the locations comprise users, groups, and business objects.

In an embodiment, displaying comprises displaying a drop down menu of suggested topics in response to a request from the user to associate topics to a post.

In an embodiment, displaying comprises displaying a drop down menu of suggested topics in real time responsive to the user composing the post.

In an embodiment, the affinity index is based on interactions between the plurality of topics and the plurality of locations, including comments, tags, re-shares, and likes.

In an embodiment, the suggested topics are determined based on at least one of: i) the highest affinity of a topic to a location; ii) the average affinity of a topic to a location; iii) the highest type average affinity of a topic to a location; iv) the minimum affinity of a topic to a location being higher than a threshold value; and v) the aggregate affinity of a topic to a location.

In an embodiment, the suggested topics are determined based on key words in a post composed by the user.

In an embodiment, the suggested topics are determined based on natural language techniques applied to a post composed by the user.

In an embodiment, the affinity index is configured to map words and phrases to topics.

In an embodiment, the suggested topics are determined based on the frequency and recency with which a topic is associated with a location. A method is also provided for identifying an expert in a social network. The method includes: receiving, from computing devices associated with members of a community, data objects corresponding to questions relating to a topic; presenting the questions to members of the community; posting the data objects to a leaderboard in a database; determining whether answers to the questions received from members of the community are correct by one of: i) feedback from the member posing the question; and ii) consent of the community; updating each data object in the leaderboard to include its answer, indicia of the member submitting the answer, and indicia of the correctness of the answer; calculating scores for the members submitting answers based on the updated data objects; and populating the identities of members having high scores on a topic page associated with the topic.

In an embodiment, calculating comprises: awarding positive points for correct answers; awarding negative points for incorrect answers; weighting positive and negative points differently; and taking into account the frequency of incorrect answers.

The method may also include: determining if the scores satisfy a predetermined threshold; for each answering member having a score which satisfies the predetermined threshold, endorsing the answering member as an expert on the topic through at least one of i) a first endorsement object indicating an expertise level for the topic on a page associated with the answering member, and ii) a second endorsement object indicating an expertise level for the answering member on the topic page.

In an embodiment, calculating scores comprises maintaining an expertise table which maps each answering member to correct and incorrect answers for a plurality of topics.

A method is also provided for connecting users with experts in a social network. The method includes: maintaining an expertise table in a database associated with the social network for mapping a plurality of experts to a plurality of topics; receiving, from a computing device associated with a first user, a data object corresponding to a question relating to a first one of the topics; retrieving a list of experts on the first topic from the expertise table; displaying, for the first user, the list of experts; and in response to the selection by the user of a first expert from the list of experts, automatically displaying the question in a feed associated with the first expert.

The method may also include providing an answer from the first expert to the user, and determining whether the answer is correct by one of: i) feedback from the user; and ii) consent of a community of users; and updating the expertise table to account for the correctness of the answer.

In an embodiment, displaying the list of experts comprises displaying a drop down menu of suggested experts in response to a request from the user for an answer.

The method may also include presenting the user with a virtual button for requesting an answer.

In an embodiment, the request from the user for an answer comprises receiving, from the user, a predetermined symbol embedded in the text of the question.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions.

For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another. That said, in exemplary embodiments, the subject matter described herein is implemented in conjunction with a virtual customer relationship management (CRM) application in a multi-tenant environment.

Other implementations may include a non-transitory computer readable storage medium storing instructions executable by a processor to perform a method as described above. Yet another implementation may include a system including memory and one or more processors operable to execute instructions, stored in the memory, to perform a method as described above.

The examples illustrating the use of technology disclosed herein through social networking system should not be taken as limiting or preferred. This example sufficiently illustrates the technology disclosed without being overly complicated. It is not intended to illustrate all of the technologies disclosed. For instance, it does not illustrate the use of tagging mechanism in enterprise applications and other personalized applications and with a multi-tenant database with complex and sophisticated architecture.

A person having ordinary skill in the art may appreciate that there are many potential applications for one or more implementations of this disclosure and hence, the implementations disclosed herein are not intended to limit this disclosure in any fashion.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed:

1. A method of qualifying a candidate as an expert on a topic in a database system computing environment, comprising:
receiving at the database system, from computing devices at least temporarily associated with identified users, qualifying objects associated with the candidate indicating at least one of: i) the candidate has participated in a thread regarding a given topic; ii) the candidate has been identified in the thread regarding the topic; iii) a comment from the candidate has been favorably identified by a user; and iv) a comment from the candidate has been unfavorably identified by a user;
evaluating according to a rule in the database system an expertise value based on at least one of the qualifying objects received during a time period;
if the expertise value satisfies predetermined threshold, endorsing the candidate as an expert on the topic through at least one of:
a first endorsement object indicating an expertise level for the topic on a page associated with the candidate; and
a second endorsement object indicating an expertise level for the candidate on a page associated with the topic.

2. The method of claim 1, further comprising:
providing a third object to link at least one of the users to the endorsed candidate based upon an assistance object received from the user, the assistance object including information indicating that the user could benefit from the assistance of a qualified expert on the topic.

3. The method of claim 1, wherein the time period is configurable by the user.

4. The method of claim 1, wherein evaluating comprises evaluating qualifying objects received during a time period comprising a predetermined number of days, weeks, or months.

5. The method of claim 1, wherein the qualifying objects comprise at least one of @mentioning, liking, and re-sharing a post authored by the candidate.

6. The method of claim 1, wherein the first endorsement object comprises a like icon on the candidate's user page, and the second endorsement object comprises a like icon on topic's page.

7. The method of claim 1, wherein evaluating the expertise value comprises maintaining an affinity index in the database system which maps a plurality of qualifying objects to a plurality of candidates.

8. The method of claim 7, further comprising updating the affinity index upon selection of the first or second endorsement objects by a user.

9. The method of claim 1, further comprising presenting the thread in a social network feed.

10. The method of claim 1, wherein the predetermined threshold comprises a number of tracked qualifying objects in the range of 3 to 20.

11. The method of claim 2, wherein the assistance object comprises a post designated as a question.

12. The method of claim 2, wherein providing the third object comprises displaying a drop down menu listing qualified candidates.

13. The method of claim 12, further comprising, in response to the user selecting one of the listed candidates, notifying the listed candidate.

14. The method of claim 13, wherein notifying comprises displaying a question in the selected candidate's feed.

15. A method of identifying and displaying current topics on a profile page in a social network, the method comprising:
maintaining in real time an index table in a database system which tracks, for each of a plurality of topics, the number of instances in which: i) an author of a post embeds indicia of the topic in the body of the post; ii) a user associates the topic with an existing post; iii) a user comments on a post associated with the topic; iv) a user responds to a post associated with the topic; v) a post associated with the topic is republished; and vi) a post associated with the topic is favorably identified by a user;
determining respective frequency scores for each of the plurality of topics based on the index table;
determining respective time adjusted frequency scores for each of the plurality of topics based on the frequency scores and a time decay factor;
identifying the top N time adjusted frequency scores, where N is in the range of three to twenty; and
displaying indicia of N topics corresponding to the N time adjusted frequency scores on the profile page.

16. The method of claim 15, wherein displaying comprises exposing N topic names in a widget, and further wherein the profile page comprises at least one of a user profile page and a group profile page.

17. The method of claim 16, further comprising:
determining respective user frequency scores for each of a plurality of users based on the index table;
determining respective time adjusted user frequency scores for each of the plurality of users based on the user frequency scores and a time decay factor;
identifying the top N time adjusted user frequency scores, where N is in the range of three to twenty; and
displaying indicia of N users corresponding to the N time adjusted user frequency scores on each of a plurality of topic pages.

18. A method for automatically suggesting topics in a social network feed, comprising:
tracking the affinity of a plurality of topics to a plurality of locations;
storing the tracked affinities in an affinity index;
displaying suggested topics for a user to associate with a post user based on the affinity index; and
updating the affinity index if the user associates the post with one of the suggested topics.

19. The method of claim 18, wherein the locations comprise users, groups, and business objects.

20. The method of claim 18, wherein displaying comprises displaying a drop down menu of suggested topics in response to a request from the user to associate topics to a post.

21. The method of claim 18, wherein displaying comprises displaying a drop down menu of suggested topics in real time responsive to the user composing the post.

22. The method of claim 18, wherein the affinity index is based on interactions between the plurality of topics and the plurality of locations, including comments, tags, re-shares, and likes.

23. The method of claim 18, wherein the suggested topics are determined based on at least one of: i) the highest affinity of a topic to a location; ii) the average affinity of a topic to a location; iii) the highest type average affinity of a topic to a location; iv) the minimum affinity of a topic to a location being higher than a threshold value; and v) the aggregate affinity of a topic to a location.

24. The method of claim 18, wherein the suggested topics are determined based on key words in a post composed by the user.

25. The method of claim 18, wherein the suggested topics are determined based on natural language techniques applied to a post composed by the user.

26. The method of claim 22, wherein the affinity index is configured to map words and phrases to topics.

27. The method of claim 18, wherein the suggested topics are determined based on the frequency and recency with which a topic is associated with a location.

28. A method for identifying an expert in a social network, comprising:
receiving, from computing devices associated with members of a community, data objects corresponding to questions relating to a topic;
presenting the questions to members of the community;
posting the data objects to a leaderboard in a database;
determining whether answers to the questions received from members of the community are correct by one of: i) feedback from the member posing the question; and ii) consent of the community;
updating each data object in the leaderboard to include its answer, indicia of the member submitting the answer, and indicia of the correctness of the answer;
calculating scores for the members submitting answers based on the updated data objects; and
populating the identities of members having high scores on a topic page associated with the topic.

29. The method of claim 28, wherein calculating comprises:
awarding positive points for correct answers;
awarding negative points for incorrect answers;
weighting positive and negative points differently; and
taking into account the frequency of incorrect answers.

30. The method of claim 28, further comprising:
determining if the scores satisfy a predetermined threshold;
for each answering member having a score which satisfies the predetermined threshold, endorsing the answering member as an expert on the topic through at least one of:
a first endorsement object indicating an expertise level for the topic on a page associated with the answering member; and
a second endorsement object indicating an expertise level for the answering member on the topic page.

31. The method of claim 28, wherein calculating scores comprises maintaining an expertise table which maps each answering member to correct and incorrect answers for a plurality of topics.

32. A method of connecting users with experts in a social network, comprising:
maintaining an expertise table in a database associated with the social network for mapping a plurality of experts to a plurality of topics;
receiving, from a computing device associated with a first user, a data object corresponding to a question relating to a first one of the topics;
retrieving a list of experts on the first topic from the expertise table;
displaying, for the first user, the list of experts; and
in response to the selection by the user of a first expert from the list of experts, automatically displaying the question in a feed associated with the first expert.

33. The method of claim 32, further comprising:
providing an answer from the first expert to the user; and
determining whether the answer is correct by one of: i) feedback from the user; and ii) consent of a community of users; and
updating the expertise table to account for the correctness of the answer.

34. The method of claim 32, wherein displaying the list of experts comprises displaying a drop down menu of suggested experts in response to a request from the user for an answer.

35. The method of claim 34, further comprising presenting the user with a virtual button for requesting an answer.

36. The method of claim 34, wherein the request from the user for an answer comprises receiving, from the user, a predetermined symbol embedded in the text of the question.
